(19) United States
(12) Patent Application Publication
(10) Pub. No.: US 2007/0112868 A1
(43) Pub. Date: May 17, 2007

(54) Storage management system and method

(76) Inventors: Curtis P. Kolovson, Cupertino, CA (US); Arun Lakshmipathy, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/274,055

(22) Filed: Nov. 14, 2005

(30) Foreign Application Priority Data
Nov. 11, 2005 (GB) 0424873.8

(51) Int. Cl. G06F 17/30

(52) U.S. Cl. 707/200

(57) ABSTRACT

A storage management system and method for managing storage in a computing storage environment, the system comprising a storage administration computing system programmed or operable to perform a plurality of high level commands for initiating respective sequences of storage management actions in the computing storage environment.

### FIELD OF THE INVENTION

The present invention relates to a storage management system and method for use in computing environments, of particular but by no means exclusive application in providing unified storage management in such environments.

### BACKGROUND OF THE INVENTION

Storage management has evolved into a highly complex task. Database Administrators (DBAs) and Storage Administrators (SAs) must presently master a collection of management consoles for each of the levels and components of the storage hierarchy, including Storage Area Networks (SANs), disk arrays, volume managers, file systems, data cloning and backup solutions, and disaster recovery solutions.

There exist three principal broad approaches to storage management: (1) storage virtualization, (2) database/application-based storage managers, and (3) enterprise system management frameworks that support storage management.

Storage virtualization, in which storage is virtualized from the perspective of the host system, has been implemented in a variety of ways; examples include the products provided by DataCore (a trade mark of Comdisco, Inc.), FalconStor, Inc., IBM/Hitachi, Microsoft VDS, HP StorageApps sv3000 and EMC. These are similar from a functional point of view. Each generally supports an abstraction of virtual pool(s) of storage that can be managed through a set of commands that operate across an entire storage pool. Storage virtualization attempts to simplify storage management, as DBAs and SAs need only manage a pool of storage using one set of commands. However, storage virtualization conceals fundamental information about data topology and restricts the ability of DBAs and SAs to perform all management tasks.

Database/application-based storage managers (as provided by, for example, Oracle International Corporation and SAP Aktiengesellschaft, and by Microsoft Corporation in its .NET servers) shift some storage related functionality into the database or application, such as striping, mirroring, cloning, RAID modes (i.e. levels of redundancy in a Redundant Array of Independent Disks), etc. However, DBAs and SAs generally require more functionality than is supported by such “built-in” storage managers so, as the other storage components (e.g. SAN management, disk arrays, DR solutions, etc.) continue to be entities that are managed separately, the DBAs and SAs still face management complexity.

Enterprise System Management Frameworks (ESMFs), such as those marketed as Tivoli (a trade mark of International Business Machines Corporation), OpenView (a trade mark of Hewlett-Packard Company) and UniCenter (a trade mark of Computer Associates International, Inc.), have existed for some time, but have only recently been provided with support for storage management. These tools attempt primarily to fulfill two main roles: 1) monitoring and event notification, and 2) single- and multi-system management tasks. In the second category, the storage management tasks that are supported include host-based and device-related storage management tasks. However, these tools typically work at the level of configuration tasks that are generic across a class of storage devices, and do not drill down to device-specific configuration tasks. In some cases, ESMFs open a device-specific management console to perform a lower level task at the appropriate point in a high-level operation. While this provides some level of integration, a DBA/SA must still master configuration commands at multiple levels of the storage hierarchy. The ESMF may even add complexity by introducing new ESMF-specific commands that are generic across device types.

### SUMMARY OF THE INVENTION

The invention provides a system and method for providing unified storage management.

In particular, according to an exemplary embodiment, there is provided a storage management system for managing storage in a computing storage environment, comprising:
a storage administration computing system programmed or operable to perform a plurality of high level commands for initiating respective sequences of storage management actions in the computing storage environment.

Thus, an operator can—according to this embodiment—employ the set of high level, preferably application-oriented, commands that obviate the need for him or her to perform a sequence of lower level tasks across the generally multiple storage sub-systems of the computing storage environment. For example, to create a database (a high level task), the operator merely performs that one task, as opposed for example to creating LUNs, creating a logical volume, creating a file system, and then creating a database based on using entities created by all the lower level steps.

It will be understood that the computing storage environment will generally comprise a plurality of networked computing devices. Some of these devices may comprise networked storage devices, such as arrays of hard disks.

In one embodiment, the storage administration computing system includes storage management software executable thereon for controlling the storage administration computing system to perform the high level commands.

In another embodiment, the high level commands are application-oriented commands.

In a particular embodiment, the storage administration computing system is programmed or operable virtualize storage management on the computing storage environment up to an application layer of the computing storage environment, and thereby simplify the storage management.

In still another embodiment, the computing storage environment includes the storage administration computing system.

The system may include a storage stack with a plurality of layers provided with control points for integrating some or all of the layers.

Thus, a SA/DBA need not master multiple storage configuration tools for configuring storage at each level of the storage stack. In this embodiment, the system may include application further including application specific plug-in components residing over the integrated layers to translate application domain syntax and semantics to storage decisions at appropriate levels.

The storage management software may be operable to perform storage resource discovery, whereby storage resources can be discovered and maintained in a storage management meta data repository. These commands may have a scope that spans multiple storage hierarchy levels.

In a particular embodiment, the storage administration computing system includes a Meta Command Engine that supports storage management meta commands. In some cases, the Meta Command Engine can be called by any of a plurality of Meta Command Engine client modules, through a storage utility Application Programming Interface (API).

A meta command is a high-level command for performing an application-related task that may involve the invocation of a sequence of lower-level commands at various levels of the storage hierarchy.

In a certain embodiment, the storage administration computing system includes a quality of service (QoS) policy manager in which quality of service attributes are defined for each client application residing on the computing storage environment.

The QoS attributes are typically maintained on a per application basis within a Meta Command Engine. The QoS policy manager can be application controlled.

In another aspect of the invention, there is provided a meta command software engine for managing storage in a computing storage environment, comprising a plurality of high level commands for initiating respective sequences of storage management actions in the computing storage environment.

In still another aspect, the invention provides a computer readable medium provided with program data that, when executed on a distributed computing system, implements the meta command software engine described above.

According to another exemplary embodiment, there is provided a storage management method for managing storage in a computing storage environment, comprising:
performing respective sequences of storage management actions in the computing storage environment in response to the execution of corresponding high level commands.

In one embodiment, the method includes providing storage management software executable thereon for controlling the storage administration computing system to perform the high level commands.

In another embodiment, the high level commands are application-oriented commands.

In still another embodiment, the method includes providing a storage administration computing system with software portions for virtualizing storage management on the computing storage environment up to an application layer of the computing storage environment, in order to simplify the storage management.

The method may include integrating some or all of the layers of a storage stack of the computing storage environment by providing control points in said layers. This may include translating application domain syntax and semantics to storage decisions at appropriate levels by providing application specific plug-in components over the integrated layers.

In a certain embodiment, the method includes performing storage resource discovery, whereby storage resources can be discovered and maintained in a storage management meta data repository.

The method may include providing a Meta Command Engine that supports storage management meta commands. The Meta Command Engine may be callable by any of a plurality of Meta Command Engine client modules, such as through a storage utility Application Programming Interface.

In another embodiment, the method includes defining quality of service attributes for each client application residing on the computing storage environment. This may include defining the quality of service attributes in a quality of service policy manager.

In another aspect of the invention, there is provided a computer readable medium provided with program data that, when executed on a computing system, implements the method described above.

### BRIEF DESCRIPTION OF THE DRAWING

In order that the invention may be more clearly ascertained, embodiments will now be described, by way of example, with reference to the accompanying drawing, in which:

FIG. 1 is a schematic representation of a storage system according to an embodiment of the invention;

FIG. 2 is a schematic representation of the architecture of the unified storage manager of the system of FIG. 1;

FIG. 3 is a schematic view of a data storage medium according to another embodiment of the invention.

### DETAILED DESCRIPTION OF THE EMBODIMENTS

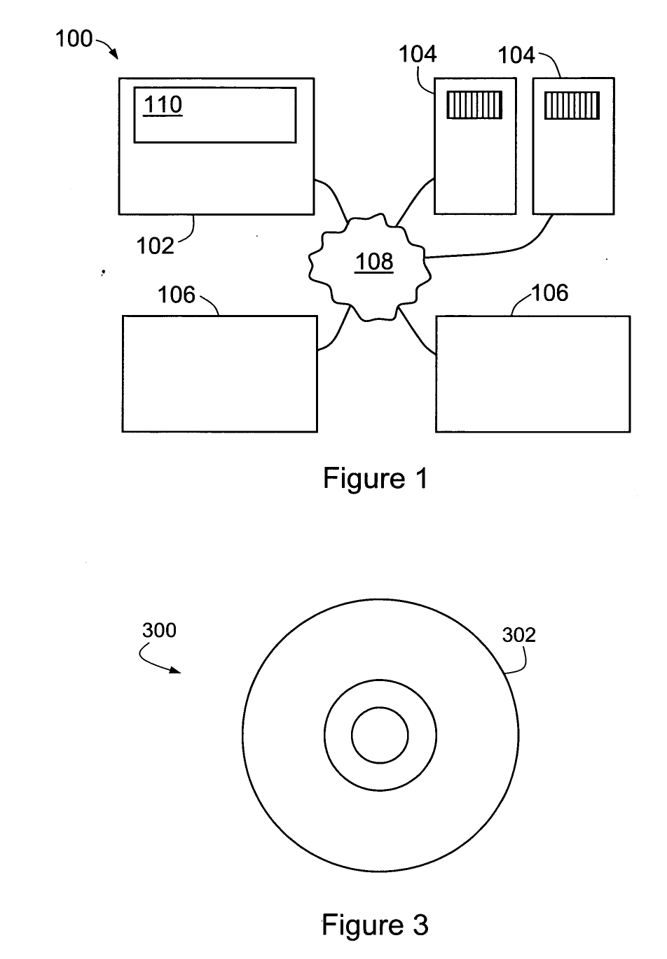

FIG. 1 is a schematic representation of a storage system 100 according to an embodiment of the invention. The system 100 includes a Storage Utility Provider (SUP) server 102, a computing storage environment in the form of storage devices 104, and client host computers 106. The Storage Utility Provider (SUP) server 102 includes a unified storage manager 108. The SUP server 102, storage devices 104, and client host computers 106 communicate via the internet 108. It will be understood that, for high availability and load balancing, there can be multiple SUPs servers, and that a single SUP server is included in this embodiment by way of illustration only.

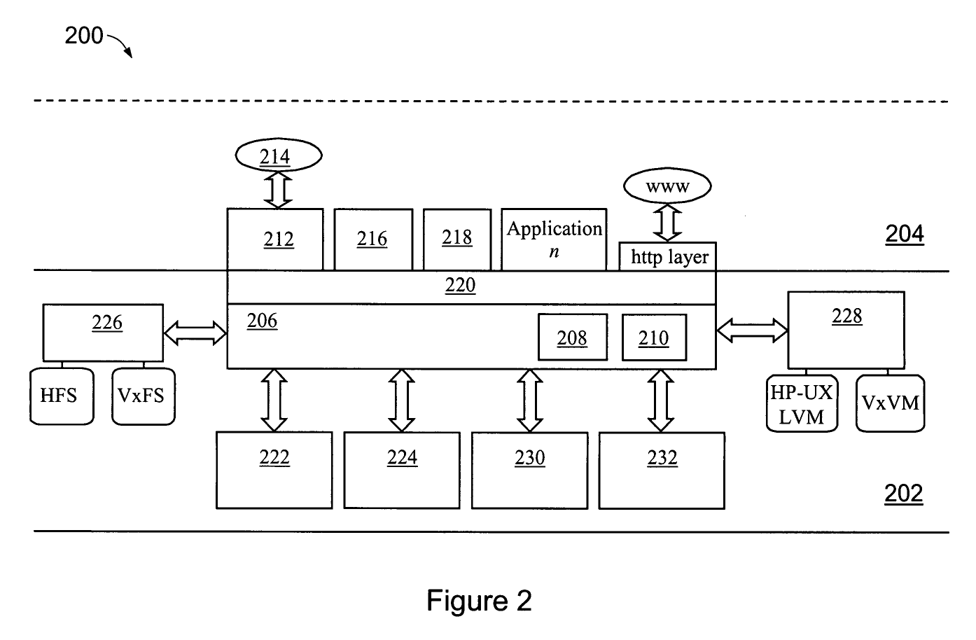

FIG. 2 is a schematic representation 200 of the architecture 202 of the unified storage manager 108 in relation to the application layer 204 of the client host computers 106. The unified storage manager 108 includes a Meta Command Engine (MCE) 206.

The MCE 206 processes Meta Commands that invoke operations at multiple levels of the storage hierarchy. The Meta Commands are a set of high level, application-oriented, commands that, in each case, are translated by the MCE 206 into sequences of low level actions. This allows an operator to use the Meta Commands instead of the corresponding sequences of lower level commands to effect tasks across multiple storage sub-systems of the computing storage environment. For example, to create a database (a high level task), the operator need only execute the command that corresponds to that one task, as opposed—for example—to creating LUNs, creating a logical volume, creating a file system, and then creating a database based on using entities created by all the lower level steps.

MCE 206 also includes a quality of service (QoS) Policy Manager 208 and a persistent Meta Data Repository 210 (in which the MCE 206 maintains its meta data), and interacts with all storage subsystems including client-, host- and storage device/appliance-based subsystems. The MCE 206 is configured to automatically perform storage resource discovery, and to maintain storage resources thus discovered in the Meta Data Repository 210. This storage resource discovery is performed at startup and subsequently whenever a Meta Command is executed that may affect storage resources.

The clients of the MCE 206 are general-purpose management interfaces including a storage management API 212 and a GUI 214, and application-specific modules such as a module 216 for Oracle and a module 218 for SAP. Each MCE client module calls the MCE 206 through a Storage Utility API 220.

As discussed above, the MCE 206 is responsive to meta commands in the form of high-level commands that span levels of the storage hierarchy. Hence, MCE 206 interacts with each of the layers of the storage hierarchy (including disk arrays, SAN fabrics, file systems, and volume managers) via a disk array management interface 222, a SAN fabric management interface 224, a file system interface 226, and a volume manager interface 228.

Some of the meta commands are application or module specific; hence, for Oracle, for example, the meta commands “create database”, “expand database”, etc. are provided. The MCE 206 is—in this embodiment—GUI driven, but can optionally also be CLI driven, as some administrators do not use or do not trust GUIs for configuration tasks. IN this embodiment, scriptable CLIs are supported that provide a configuration change audit trail.

The MCE 206 also supports extensible command templates, and DBAs can define their own meta commands or modify existing ones.

Common actions implemented as meta commands supported by the MCE 206 include commands for:
the creation of a database;
the deletion of a database;
the addition of tablespace;
the addition of an online log;
the addition of a controlfile;
the addition of a host or hosts to set (hosts) with access to a database;
the addition of a user or users to set (users) with access to a database;
the addition of bandwidth to set (hosts, databases);
the addition of redundant paths to set (hosts, databases);
the cloning of a database; and
the replication of a database to set (hosts).

In addition, MCE 206 maintains storage component health information and performance metrics for each level of the storage via a performance metrics and health monitoring interface 230, and performs data backing up via backup and data cloning interface 232.

MCE 206 can automatically design and recommend storage and database configurations based on high-level requirements for storage layers specified by a DBA; the DBA, however, can review a recommended design and make modifications. The MCE 206 can then create the storage and database configuration as finally specified by the DBA.

The MCE 206 also automatically monitors performance and auto-reconfigures over time to maintain performance SLAs.

The following is a description of the initial startup of the MCE 206 and an example of its use. At startup, the MCE 206 automatically queries all levels of the storage hierarchy, through a storage resource discovery interface, in order to enumerate all storage related resources and components (viz. hosts, HBAs, SAN fabrics, LUNs, Disk Arrays, JBODs, files systems, volume managers, etc.). The discovery interface invokes storage management data providers, such those conforming to the SNIA Bluefin Specification. The MCE 206 retrieves—as required—QoS definitions stored in the QoS Policy Manager 208 (which are extensible and may be user-defined); for illustrative purposes, it is assumed that the following QoS levels have been defined:

| QoS Attribute | Value | Definition |
|---|---|---|
| Availability | 0 | no RAID |
| | 1 | RAID, multi-path |
| | 2 | RAID, multi-path, DR solution |
| | . . . | . . . |
| Scalability | 0 | Space reqd expected to be ˜constant |
| | 1 | Space reqd to increase ˜10-20% annually |
| | 2 | Space reqd to increase ˜20-30% annually |
| | . . . | . . . |
| Performance | 0 | File system, LVM, RAID 5 |
| | 1 | Raw logical volumes, RAID 5 |
| | 2 | 2-way striped raw logical volumes, RAID 1 |
| | 3 | 4-way striped raw logical volumes, RAID 1 |
| | . . . | . . . |

### EXAMPLE

Assuming this configuration, a DBA wants to create a 60 GB volume for hosting his or her Oracle database. The DBA specifies QoS factors of 1 for availability, 1 for scalability and 2 for performance, and a locality parameter specifying the disk array on which the data is to be hosted.

To perform this operation the Oracle Module 216 provides a Meta Command createdb, which would receive the size parameter, QoS attribute values, Oracle file names, and an optional locality parameter that specifies which storage device(s) should host the data. If the locality parameter had been omitted, a disk array capable of supporting the requested QoS attributes is automatically selected. This createdb Meta Command is processed as follows.

If the host does not have multiple HBAs and multi-pathing software, an indication that the specified availability cannot be achieved with the current configuration is returned.

If there are 60 GB of RAID 1 LUNs available for allocation on the specified array, they are allocated; otherwise, the appropriate commands to SAN fabric and disk array management interfaces are invoked to provision the RAID 1 space for the requesting host on the specified array.

Volume manager commands are invoked to create physical volumes, volume group, and 2-way striped raw logical volumes over separate LUNs, for each of the specified Oracle data files, control files, and online log files.

An Oracle script is executed to create the database on the newly created raw logical volumes.

Thus, the concept proposed here provides an integrated storage management facility that simplifies storage administration by providing a set of high-level commands to perform application-related tasks, while allowing DBAs/SAs to have full control over how and where data is stored. In addition, this facility provides a unified topological view of how data is organized across all levels of the storage hierarchy. This allows the DBA/SA the following advantages:
Integration across all levels of storage hierarchy allowing Configuration, control and Monitoring tasks to be performed within the application domain.
Focus on application-centric management of storage resources, thereby allowing Application managers to utilize and manage storage within the syntax/semantic domains of the application.
Extensible Policy-based management functions that span levels of storage hierarchy.
Rule-based monitoring that supports root cause analysis by indicating failures at appropriate level of hierarchy Levels of severity propagate up service tree to appropriate level, e.g. failed disk in disk group means disk group transitions from normal to degraded mode, but database status is unaffected.
A single configuration and monitoring framework allows for Simplification of storage administration tasks, while still allowing control points and flexibility.
Detect usage thresholds (e.g. available space) and automatically expand storage as needed.
Automate low-level tasks thereby minimizing the possibility of user error.

Referring to FIG. 3, in another embodiment the necessary software for implementing the system of FIG. 1 is provided on a CD-ROM 300.

FIG. 3 is a schematic view of a data storage medium 300 according to another embodiment. The data storage medium 300 is in the form of a CD-ROM 302 that contains program instructions for implementing the system of FIG. 1. It will be understood that, in this embodiment, the particular type of data storage medium may be selected according to need or other requirements. For example, instead of CD-ROM 302 the data storage medium 300 could be in the form of a magnetic medium, but essentially any data storage medium will suffice.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A storage management system for managing storage in a computing storage environment, comprising:
a storage administration computing system programmed or operable to perform a plurality of high level commands for initiating respective sequences of storage management actions in the computing storage environment.

2. A system as claimed in claim 1, wherein the storage administration computing system includes storage management software executable thereon for controlling the storage administration computing system to perform the high level commands.

3. A system as claimed in claim 1, wherein the high level commands are application-oriented commands.

4. A system as claimed in claim 1, wherein the storage administration computing system is programmed or operable virtualize storage management on the computing storage environment up to an application layer of the computing storage environment, and thereby simplify said storage management.

5. A system as claimed in claim 1, wherein the computing storage environment includes the storage administration computing system.

6. A system as claimed in claim 1, wherein the system includes a storage stack with a plurality of layers provided with control points for integrating some or all of the layers.

7. A system as claimed in claim 6, further including application specific plug-in components residing over the integrated layers to translate application domain syntax and semantics to storage decisions at appropriate levels.

8. A system as claimed in claim 1, wherein the storage management software is operable to perform storage resource discovery, whereby storage resources can be discovered and maintained in a storage management meta data repository.

9. A system as claimed in claim 1, wherein the storage administration computing system includes a Meta Command Engine that supports storage management meta commands.

10. A system as claimed in claim 9, wherein the Meta Command Engine can be called by any of a plurality of Meta Command Engine client modules, through a storage utility Application Programming Interface.

11. A system as claimed in claim 1, wherein the storage administration computing system includes a quality of service policy manager in which quality of service attributes are defined for each client application residing on the computing storage environment.

12. A meta command software engine for managing storage in a computing storage environment, comprising a plurality of high level commands for initiating respective sequences of storage management actions in the computing storage environment.

13. A computer readable medium provided with program data that, when executed on a distributed computing system, implements the meta command software engine of claim 12.

14. A storage management method for managing storage in a computing storage environment, comprising:
performing respective sequences of storage management actions in the computing storage environment in response to the execution of corresponding high level commands.

15. A method as claimed in claim 14, including providing storage management software executable thereon for controlling the storage administration computing system to perform the high level commands.

16. A method as claimed in claim 14, wherein the high level commands are application-oriented commands.

17. A method as claimed in claim 14, including providing a storage administration computing system with software portions for virtualizing storage management on the computing storage environment up to an application layer of the computing storage environment, in order to simplify said storage management.

18. A method as claimed in claim 14, including integrating some or all of the layers of a storage stack of the computing storage environment by providing control points in said layers.

19. A method as claimed in claim 18, further including translating application domain syntax and semantics to storage decisions at appropriate levels by providing application specific plug-in components over the integrated layers.

20. A method as claimed in claim 14, including performing storage resource discovery, whereby storage resources can be discovered and maintained in a storage management meta data repository.

21. A method as claimed in claim 14, including providing a Meta Command Engine that supports storage management meta commands.

22. A method as claimed in claim 21, including making the Meta Command Engine callable by any of a plurality of Meta Command Engine client modules.

23. A method as claimed in claim 14, including defining quality of service attributes for each client application residing on the computing storage environment.

24. A method as claimed in claim 23, including defining the quality of service attributes in a quality of service policy manager.

25. A computer readable medium provided with program data that, when executed on a distributed computing system, implements the method of claim 14.
